(19) United States
(12) Patent Application Publication
(10) Pub. No.: US 2017/0011229 A1
(43) Pub. Date: Jan. 12, 2017

(54) SYSTEM FOR AGGREGATION AND USER SELF-DIRECTION OF USER DATA SHARE TO OTHER SYSTEMS

(71) Applicant: BANK OF AMERICA CORPORATION, Charlotte, NC (US)

(72) Inventors: Alicia C. Jones-McFadden, Fort Mill, SC (US); Matthew Hsieh, Charlotte, NC (US); Jade Michelle Le Vo-Dinh, Charlotte, NC (US); David M. Grigg, Rock Hill, SC (US); Carrie Anne Hanson, Charlotte, NC (US); Peter John Bertanzetti, Charlotte, NC (US)

(21) Appl. No.: 14/796,960

(22) Filed: Jul. 10, 2015

(51) Int. Cl. G06F 21/62; G06Q 40/00; G06F 3/0484

(52) U.S. Cl. CPC G06F 21/6245; G06F 3/04842; G06Q 40/00

(57) ABSTRACT

The present disclosure describes user self-directed sharing of user data with entities in return for user benefits. Embodiments herein disclosed receive user data, aggregate the user data into user data groups, receive at least one benefit that an entity is willing to offer in exchange for a user data group, associate the benefit with each of the user data groups, provide a user interface to the user, prompt the user for selecting one of the user data groups and the benefit for the selected user data group, receive an indication that the user has selected to share one of the user data groups in exchange for the benefit, provide the user data associated with the selected user data group to the entity associated with the benefit, and provide a notification to the user of the benefit associated with the selected user data group has been associated with the user.

### FIELD OF THE INVENTION

This disclosure generally relates to user self-directed sharing of user data with entities in return for user benefits.

### BACKGROUND

Unauthorized or uncontrollable sharing of user data between a financial institute that a user is affiliated with and third-parties who want to know about the user's financial information posts clear adverse effects to the user's discretion on what to do with his own data. Accordingly, it would be desirable to defer decision-making to a user on the user data. In particular, it would be desirable that a user has control over what sort of user data he wants to share with which party in exchange for what benefits.

### SUMMARY OF INVENTION

The following presents a summary of certain embodiments of the present invention. This summary is not intended to be a comprehensive overview of all contemplated embodiments, and is not intended to identify key or critical elements of all embodiments nor delineate the scope of any or all embodiments. Its sole purpose is to present certain concepts and elements of one or more embodiments in a summary form as a prelude to the more detailed description that follows.

Methods, systems, and computer program products are described herein that provide for user self-directed sharing of user data with entities in return for user benefits.

Some embodiments characterize a system that includes a computing platform including one or more processing devices and executable software code stored in one or more electronic storage devices. The executable software code is configured to cause the processing devices to receive user data associated with a user of a financial institution, wherein the user data includes at least transaction data, investment data, and user profile data. The executable software code is further configured to aggregate the user data into at least two user data groups and store the user data groups in the storage devices; receive at least one benefit that at least one entity is willing to offer to the user in exchange for the user data; and associate the at least one benefit with each of the user data groups. The executable software code is additionally configured to provide a user interface to the user; prompt the user, via the user interface, for selection of at least one of the user data groups and at least one benefit for each of the data groups; receive an indication that the user has selected to share the at least one of the user data groups in exchange for the at least one benefit; provide the user data associated with the at least one of the user data groups to the entity associated with the at least one benefit; and provide a notification to the user that the at least one benefit associated with the at least one of the user data groups is associated with the user.

Some embodiments feature a computer implemented method for user self-directed sharing of user data with entities in return for user benefits. The method performs multiple steps, all via a processing device, including: receiving user data associated with a user of a financial institution, wherein the user data comprises at least transaction data, investment data, and user profile data. The method further includes the steps of: aggregating the user data into at least two user data groups and store the user data groups in the storage devices; receiving at least one benefit that at least one entity is willing to offer to the user in exchange for the user data; and associating the at least one benefit with each of the user data groups. The method additionally includes providing a user interface to the user; prompt the user, via the user interface, for selection of at least one of the user data groups and at least one benefit for each of the data groups; receiving an indication that the user has selected to share the at least one of the user data groups in exchange for the at least one benefit; providing the user data associated with the at least one of the user data groups to the entity associated with the at least one benefit; and providing a notification to the user that the at least one benefit associated with the at least one of the user data groups is associated with the user.

Further embodiments provide a computer program product for user self-directed sharing of user data with entities in return for user benefits, which includes a non-transitory computer readable medium including computer readable instructions. The computer readable instructions include instructions for receiving user data associated with a user of a financial institution, wherein the user data comprises at least transaction data, investment data, and user profile data. The computer readable instructions further include instructions for aggregating the user data into at least two user data groups and store the user data groups in the storage devices; receiving at least one benefit that at least one entity is willing to offer to the user in exchange for the user data; and associating the at least one benefit with each of the user data groups. The computer readable instructions additionally include instructions for providing a user interface to the user; prompt the user, via the user interface, for selection of at least one of the user data groups and at least one benefit for each of the data groups; receiving an indication that the user has selected to share the at least one of the user data groups in exchange for the at least one benefit; providing the user data associated with the at least one of the user data groups to the entity associated with the at least one benefit; and providing a notification to the user that the at least one benefit associated with the at least one of the user data groups is associated with the user.

Implementations may include one or more of the following features.

In some implementations, the executable software code of the system is further configured to cause the one or more processing devices to: 1) receive an indication that the user selected a non-sharing data group, wherein the non-sharing data group is one of the at least two user data groups that the user will not exchange with at least one entity for at least one benefit; and 2) withhold the user data associated with the non-sharing data group from the at least one entity.

In some implementations, the at least one benefit includes at least one of cash, credits, discounts, loyalty points, added personal services, improved personal services, and better website experience.

In some implementations, the value of the at least one benefit is increased based on an increase in the amount of user data provided in exchange for the benefit.

In some implementations, the executable software code of the system is further configured to cause the one or more processing devices to: 1) provide a notification to the user that at least one additional benefit is available if the user will select at least one additional data group, based on the selected user data groups and at least one unselected user data group, wherein the at least one additional data group is the at least one unselected user data group; 2) prompt the user for selection of the at least one additional user data group and the at least one additional benefit for each, wherein the prompt is provided through the user interface on the user system; 3) receive an indication that the user selected to share the at least one additional user data group in exchange for the at least one additional benefit, wherein the indication is received through the user system; 4) provide the user data associated with the at least one additional user data group to the entity associated with the at least one additional benefit selected, wherein the user data is provided by the financial institution system or the entity system; and 5) provide a notification to the user of the at least one additional benefit associated with the at least one additional data groups is associated with the user, wherein the notification is provided on the user interface through the user system.

In some implementations, In some implementations, the executable software code of the system is further configured to cause the one or more processing devices to: 1) prompt the user for selection of at least one of the at least one entity, wherein the prompt is provided through the user interface on the user system; 2) receive an indication that the user selected the at least one selected entity; and 3) prompt the user for selection of at least one of the at least two data groups and the at least one benefit for each, wherein the at least one benefit is associated with the at least one selected entity, and wherein the prompt is provided through the user interface on the user system.

To the accomplishment of the foregoing and related objectives, the embodiments of the present invention comprise the function and features hereinafter described. The following description and the referenced figures set forth a detailed description of the present invention, including certain illustrative examples of the one or more embodiments. The functions and features described herein are indicative, however, of but a few of the various ways in which the principles of the present invention may be implemented and used and, thus, this description is intended to include all such embodiments and their equivalents.

The features, functions, and advantages that have been discussed may be achieved independently in various embodiments of the invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a flowchart illustrating a general process for user self-directed sharing of user data with entities in return for user benefits, in accordance with an embodiment of the invention;

FIG. 2 is a flowchart illustrating a general process for enabling a user to select additional benefits if the user is willing to share additional user data, in accordance with an embodiment of the invention;

FIG. 3 is a flowchart illustrating a general process for permitting a user to select additional entities to share user data with, in accordance with an embodiment of the invention;

FIG. 4 is a block diagram illustrating a system environment for executing the process flow described in FIGS. 1, 2 and 3, in accordance with an embodiment of the invention;

FIG. 5A is an exemplary user interface for user selection of the data components for each user data group;

FIG. 5B is an exemplary user interface for user self-directed sharing of user data with entities in return for user benefits, in accordance with an embodiment of the invention; and

FIG. 5C is an exemplary user interface for user self-directed sharing of user data with entities in return for user benefits, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, and the like, and/or may not include all of the devices, components, modules, and the like discussed in connection with the figures. A combination of these approaches may also be used.

The steps and/or actions of a method or algorithm described in connection with the embodiments disclosed herein may be embodied directly in hardware, in one or more software modules (also referred to herein as computer-readable code portions) executed by a processor or processing device and configured for performing certain functions, or in a combination of the two. A software module may reside in RAM memory, flash memory, ROM memory, EPROM memory, EEPROM memory, registers, a hard disk, a removable disk, a CD-ROM, or any other form of non-transitory storage medium known in the art. An exemplary storage medium may be coupled to the processing device, such that the processing device can read information from, and write information to, the storage medium. In the alternative, the storage medium may be integral to the processing device. Further, in some embodiments, the processing device and the storage medium may reside in an Application Specific Integrated Circuit (ASIC). In the alternative, the processing device and the storage medium may reside as discrete components in a computing device. Additionally, in some embodiments, the events and/or actions of a method or algorithm may reside as one or any combination or set of codes or code portions and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions, code, or code portions on a computer-readable medium. Computer-readable media includes both non-transitory computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Embodiments of the present invention are directed to systems, methods and computer program products for user self-directed sharing of user data with entities in return for user benefits. It is not uncommon in nowadays information environment that user data associated with a financial institute can be collected and/or used by third-parties without the user's consent. Such unauthorized or uncontrollable user data sharing posts clear adverse effects to the user's discretion on what to do with his own data. Thus, it would be desirable that a user can control over what kind of user data he wants to share with which party in exchange for what benefits. Some embodiments arise, in part, from the realization that a system can advantageously be configured to enable a user to direct sharing of user data with entities in return for user benefits. Such embodiments enable the user to control over what kind of user data to share with which entity in exchange for what benefits. Such embodiments also enable a user to exclude one or more entities with which the user decides not to share his data. Such embodiments further permit a user to select additional benefits if he is willing to share additional data and to select multiple entities to share data with.

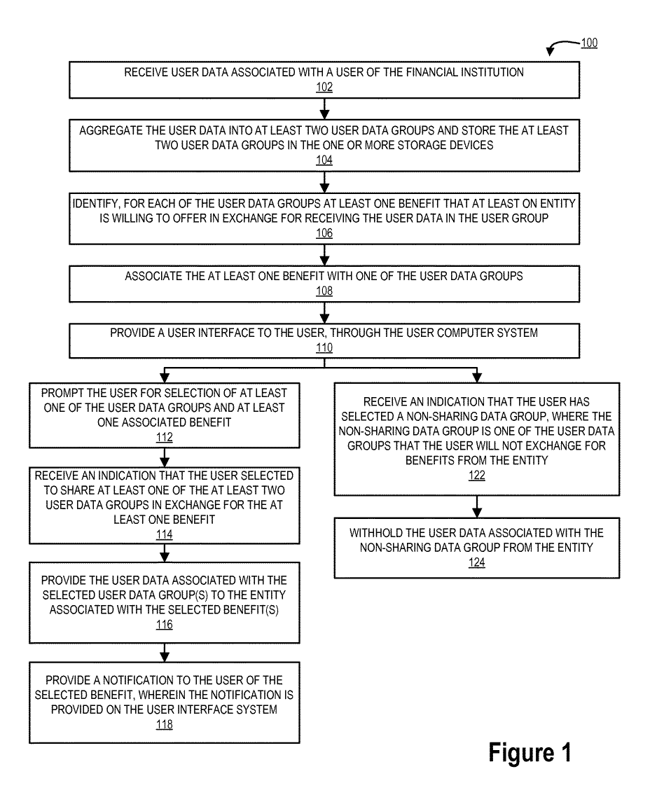

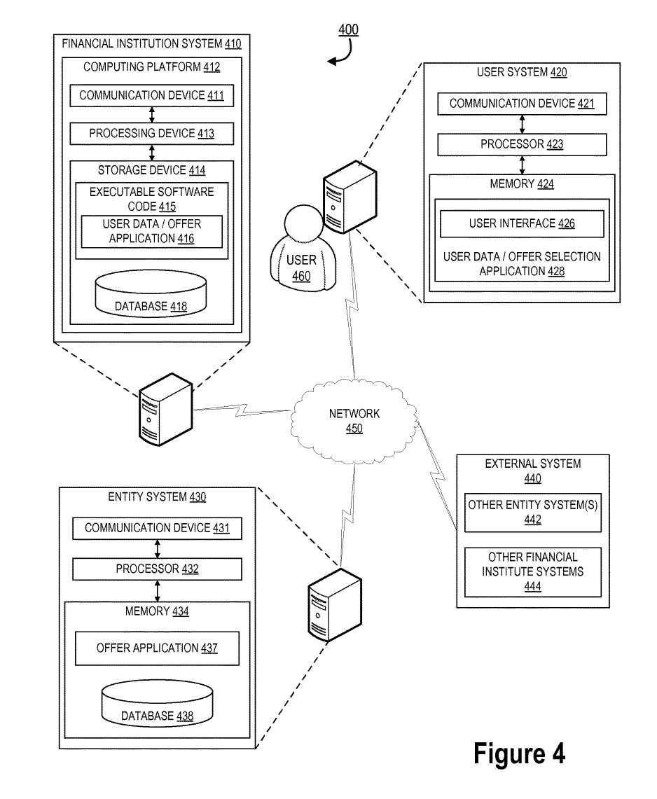

FIG. 1 illustrates a general process flow 100 for user self-directed sharing of user data with entities in return for user benefits, in accordance with embodiments of the present invention. The process 100 can be executed by a financial institute system in a system environment, for example, by the financial institute system 410 in the system environment 400, shown in FIG. 4. As used herein, the terms “user” and “customer” are interchangeable. A “user” may refer to any person associated with a financial institute, for example, a person that has an account (e.g., a checking account, a credit card account, a mortgage, or the like) managed by a financial institute.

An “entity,” as used herein, refers to any profit or non-profit organization. Profit organizations refer to companies that produce and/or provide goods and/or services, or companies that sell, offer for sale, distribute, trade, and/or otherwise deal in goods and/or services (hereinafter “products”). Profit organizations include, by way of example, phone companies, search engine companies, financial institutes, investing firms or investing firms or investment banks, mortgage companies, financial consulting firms, and the like. Non-profit organizations may be defined as groups structured for other purposes than generating profits, but may also provide the same or similar types of goods and/or services as the for profit institutions. Examples of non-profit organizations include, but are not limited to, government sponsored sectors, and government funded institutes, projects, services, and so on.

A “financial institution” or “financial institute” may refer to any organization in the business of moving, investing or lending money, dealing in financial instruments, or providing financial services. For example, a financial institute may be a commercial bank, federal and state savings bank, savings and loan association, credit union, an investment company, an insurance company, or the like.

The process 100, when executed by a financial institute system, starts with receiving 102 user data associated with a user of the financial institution. In some embodiments, the user data is composed of at least transaction data, investment data, user profile data, and account data.

The transaction data may include types of products purchased, amount of money spent on the products purchases (e.g., individual and aggregate amounts), amount of money spent in certain locations, transaction frequency, the merchant with which the transactions occurred, and the like. The transaction information may provide information related to the user's spending habits and provide insight into the benefits and/or products in which the user may be interested.

The investment data may include the user's investment strategies, trading frequencies, portfolio investment allocation, the user's investment diversification, sectors in which the user may invest, the companies the user likes to invest in, or the like. The investment data may provide insight into what investment products the user may be interested and how the user may want to translate this information into benefits received.

The user profile data may include user personal information, which may include age, education, employment, financial interests, goals, plans, favorite interests (e.g., sports teams, products, companies, and the like), locations in which the user lives, house costs, income for the user or household, or the like. The user profile data may provide insight into the type of person the user is, what the user interests are, the user's financial plans for the future, or the like. This information may also help to determine the benefits in which the user may be interested.

The account data may include information about one or more user's accounts associated with the financial institute or/and other financial institutes. An “account” may refer to a deposit account, a debt account, a savings account, an investment account, a money market account, a pre-paid account, a mortgage account, a credit account, or any other type of account. The information associated with an account may include balances, credit lines, debts, mortgage payments, what accounts the user utilizes to enter into transactions, or the like. The account data may provide insight into what the user's assets and liabilities are, and how the user may want to translate this information into benefits received.

It should be understood that some of the transaction data, investment data, user profile data, and/or the account data may have related data or data that crosses over between these different categories. As such, it should be understood that some of the data by be included in two or more of these categories of data. For example, the accounts used to make transactions may be related to the both the transaction data and the account data.

In most of cases, the user data can be received from the financial institution system that the user has a relationship with or from the user himself (e.g., by the user filling out information that the financial institution stores). Yet in some cases, the user data may be received from third-parties (e.g., other financial institutions having a relationship with the user's financial institution and/or entities that are not associated with the financial institution system) that are accessed by the financial institution and/or that the user specifically allows the financial institution to access (e.g., provides the financial institution with access to the user's accounts with third-parties).

Once the user data is received, the process 100 then progresses to aggregating 104 the user data into at least two user data groups. The user data groups may be any type of group that may be determined automatically by financial institution system 410, or grouped together by the user. For example, with respect to the financial institution automatically grouping the data together, the user data groups may include information from within a single data category (e.g., within the transaction data) or across different data categories (e.g., data from the transaction data and the data from the user profile data). The financial institution may automatically group data together based on the data requested by the entities providing the benefits in exchange for the data. For example, an entity may be interested in obtaining data for users living in a particular geographic location that enter into transactions with particular merchants, and have investments that are greater than a particular amount. As such, the entity may request this information from a financial institution, and the financial institution may automatically group this data together for its users 460 the users that meet the entities requirements.

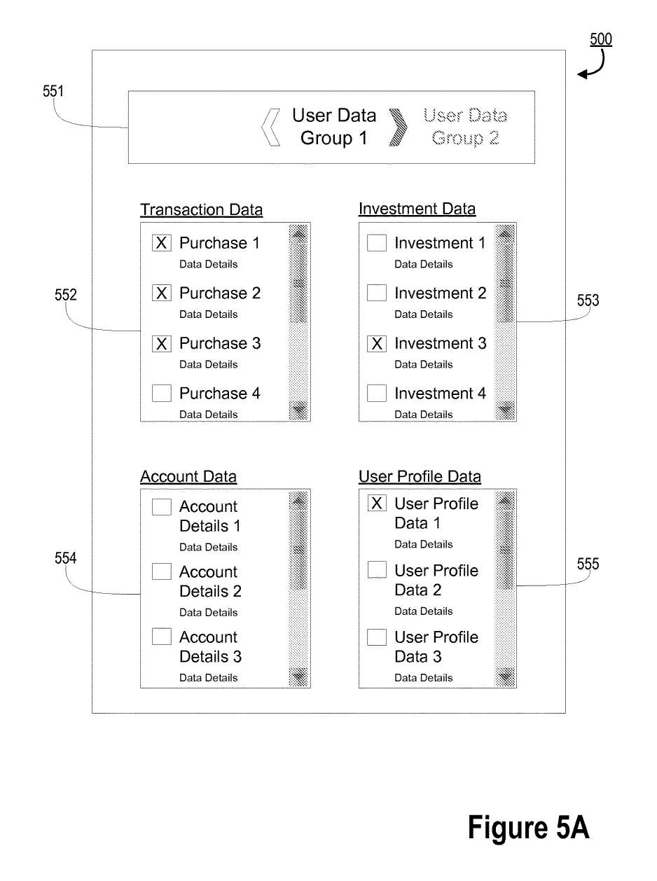

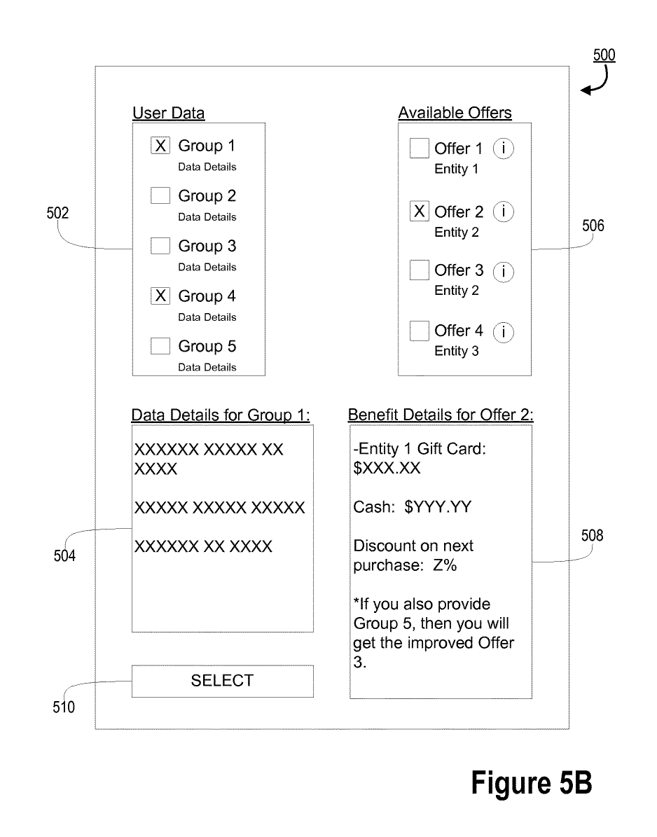

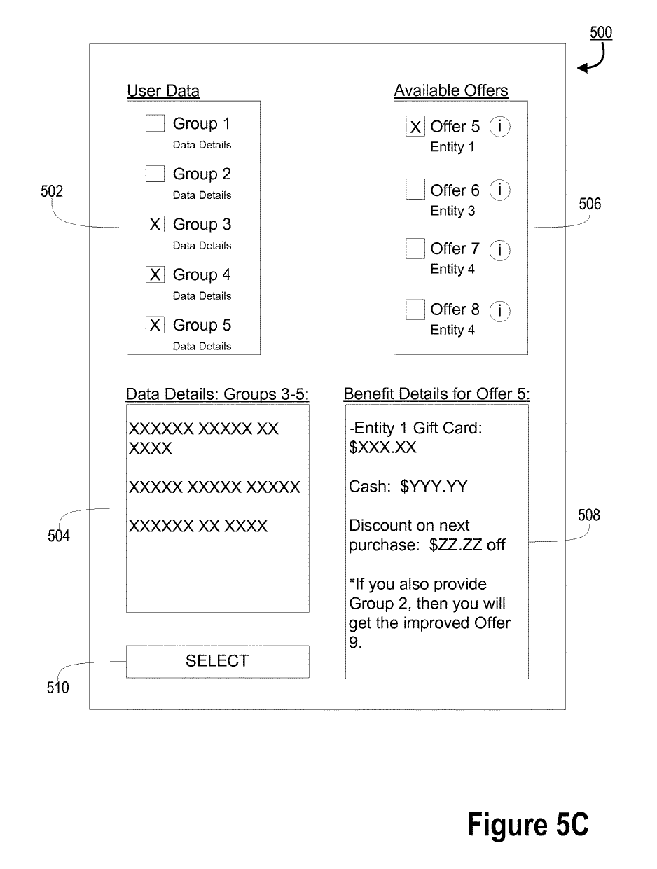

Alternatively, the financial institute may display a list of the user data to the user 460 in an interface (not illustrated) and the user 460 may select the one or more types of user data (e.g., types of data within the transaction data, investment data, user profile data, account data, or the like) to aggregate together, as illustrated in FIG. 5A. For example, the user may select to aggregate all of user transaction data together with user demographic data from the user profile information. It should be understood that any type of user data may be aggregated together automatically and/or by selection by the user and/or the financial institute. In some embodiments, the aggregated or grouped user data can be stored in one or more storage devices administrated by the financial institute system, and can also be dispatched to one of the user's computers for the user to review and archive.

Once the user data has been received and aggregated into two or more user data groups, the method 100 advances to identifying 106, for each of the user data groups, at least one benefit that at least one entity is willing to offer to the user in exchange for the user data within the user data group. Benefits may include cash, discounts, coupons, loyalty points, better interest rates, offers for products, added services to a user's current services, new services, or the like. The added or new services may include enriched experience on an organization's website, including advertisement free service on a website, elevated level of customer services (e.g., person to person advice), upgraded accounts with better benefits (e.g., free sessions with wealth managers, or the like), sales promotion events and receptions, or the like. The at least one benefit offered by the entity can be received via the financial institute system or directly from the entity system identified by the financial institute system.

Upon identification of the at least one benefit, the process 100 moves forward to associating 108 the benefit with one of the user data groups and providing 110 a user interface for presenting and/or receiving information to and/or from the user 460. In some embodiments, the “user interface” is a graphic user interface (GUI), which enables the user to interact with electronic devices through direct manipulation of graphical elements on the GUI. The graphic elements include, but are not limited to, checkboxes, buttons, radio buttons, dropdown lists, list boxes, text fields, menu bars, or the like. In some embodiments, the “user interface” may be an electronic communication interface, which can accommodate one or more input and/or output devices, such as display screens and/or speakers, keys, dials, levers, directional pads, joysticks, accelerometers, controllers, microphones, touchpads, touchscreens, scanners, motion detectors, cameras, and/or the like.

After the user interface has been provided to the user, the process 100 progresses to prompting 112, via the user interface, the user for selection of at least one of the user data groups and at least one benefit for sharing the at least one of the user data groups. This step is visualized in FIGS. 5B and 5C. If the user decides to share at least one of the data groups, (e.g., the user transaction data, or the like), then the process 100 is directed to receiving 114 an indication that the user has selected to share one of the user data groups in exchange for the benefit. The indication can be received through the user computer system. Following this direction, the process 100 continues with providing 116 the selected user data group to the entity associated with the selected benefit and providing 118 a notification to the user 460 that the benefit associated with the user data group has been associated with the user 460. In some embodiments, the notification is sent through the user interface on the user system 420.

In some cases, the user 460 may decide not to share at least one particular data group, e.g., user personal information. In such cases, the process 100 is directed to receiving 122 an indication that the user 460 has selected a non-sharing data group, where the non-sharing data group is one of the user data groups that the user will not exchange with the entity in exchange for benefits. The process 100 then proceeds with withholding 124 the user data associated with the non-sharing data group from the entity.

In some embodiments instead of the user data group being associated with a benefit before prompting the user to indicate what user data the user would like to share, the user may first select what user data group the user is interested in sharing. Thereafter, the user data groups that the user is willing share may be presented to the entities in order to receive an indication of the benefits that the entities would provide in exchange for the user data groups selected by the user.

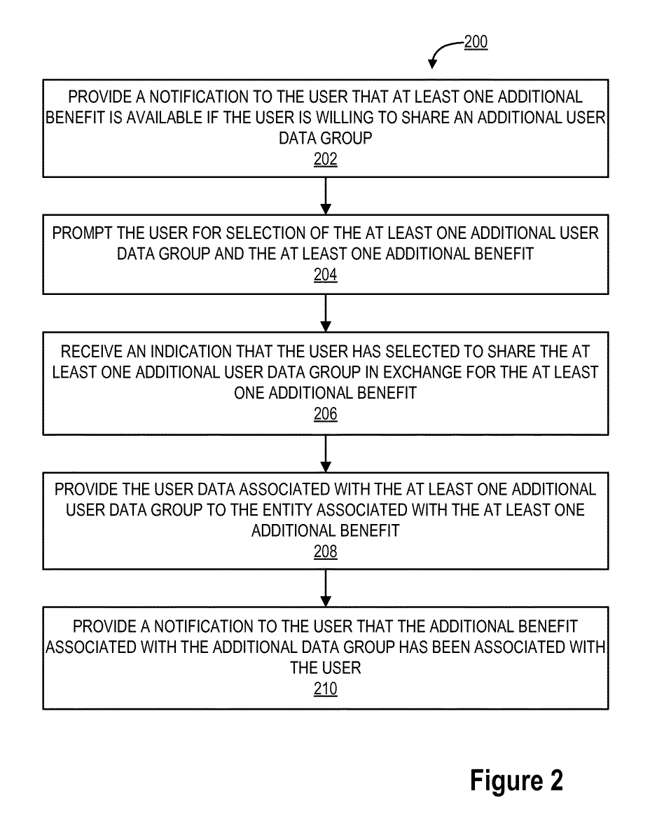

Turning now to FIG. 2, a general process flow 200 is provided for enabling the user to select additional benefits if the user is willing to share one or more additional user data groups. The process 200 includes the step of providing 202 a notification to the user 460 that at least one additional benefit (or a better benefit) is available if the user will select at least one additional data group to share with the entity along with the one or more original user data groups selected. The additional data group may be determined by allowing the user to select an unselected user data group. The process 200 further includes prompting 204 the user 460 for selection of the at least one additional user data group and/or the at least one additional benefit. In some embodiments, the prompt is provided through the user interface on the user system 420. One embodiment of this concept is illustrated in FIGS. 5B and 5C.

The process 200 next moves to receiving 206 an indication that the user has selected to share the at least one additional user data group in exchange for the at least one additional benefit (or improved benefit), wherein the indication can be received through the user system 420. The process 200 then progresses to providing 208 the user data associated with the at least one additional user data group to the entity associated with the at least one additional benefit (or improved benefit), wherein the user data is provided to the entity system via the financial institution system 410. Upon providing 208 the additional user data group to the entity for the additional benefit (or the improved benefit), the process 200 proceeds with providing 210 a notification to the user of the additional benefit (or improved benefit) associated with the additional one or more data groups that have been selected by the user. In some embodiments, the notification is provided on the user interface through the user system 420.

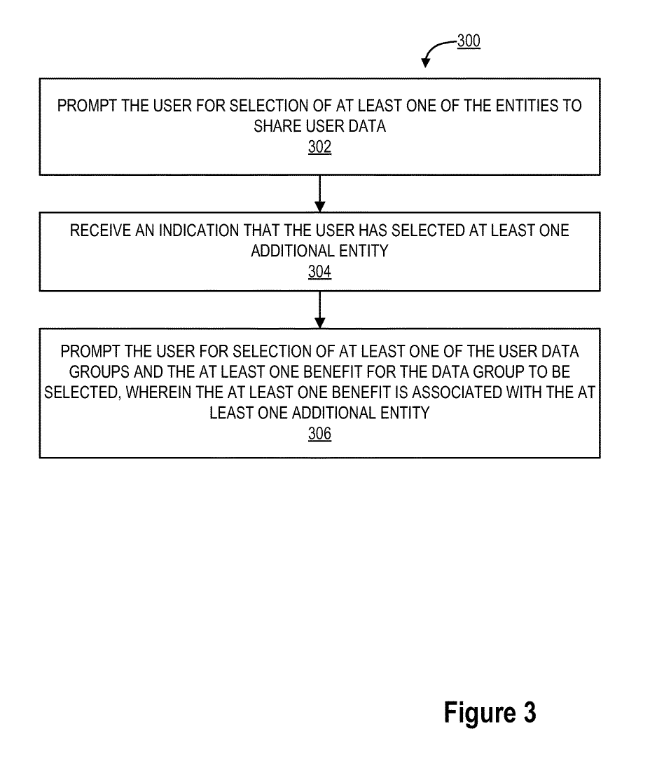

FIG. 3 illustrates another general process flow 300 for permitting the user 460 to select at least one additional entity with which the user would like to share user data (e.g., user data groups). The process 300 includes prompting 302 the user for selection of at least one of the entities with which to share user data, wherein the prompt is provided through the user interface on the user system 420. Upon prompting 302, the process 300 progresses to receiving 304 an indication that the user 460 has selected at least one additional entity. The process 300 next moves to prompting 306 the user for selection of at least one of the user data groups and the at least one benefit for the data group to be selected, wherein the at least one benefit is associated with the at least one additional entity, and wherein the prompt is provided through the user interface on the user system 420. As such, the user may share the same data to receive benefits from both entities separately, receive a single benefit that is based on sharing the data with two or more entities, sharing only a first user data group with a first entity to receive a first benefit and only a section user data group with a second entity to receive a second benefit.

Referring next to FIG. 4, a block diagram of a system environment 400 is provided, for executing the process flows 100, 200, 300, described respectively in FIGS. 1, 2 and 3. The system environment 400 includes a financial institute system 410, a user system 420, an entity system 430, and an external systems 440, communicating with one another through a network 450, and a user 460 operating on the user system 420. A “financial institute system” is typically owned or administrated by a financial institute and may include personal computers, a mainframe computers, any suitable informatics systems or a hybrid thereof. A “system environment” may be any information technology platform of an enterprise, e.g., a national or multi-national corporation, and may include a multitude of servers, machines, mainframes, personal computers, network devices, front and back end systems, database systems and/or the like.

In the embodiments shown in FIG. 4, the financial institute system 410 includes a computing platform 412, which, in turn, includes a communication device 411, at least one processing device 413, and at least one electronic storage device 414, in communication with the processing device 413. The electronic storage device 414 contains executable software code 415 including a user data/offer application 416 and a database 418 for storing user data and other business related information. In some embodiments, the financial institute system 410 is managed by the financial institute and located at a facility associated with the financial institute or remotely from a facility associated with the financial institute.

The processing device 413 includes circuitry for executing the functions of the financial institute system 410. For example, the processing device 413 can include a digital signal processor device, a microprocessor device, and various analog-to-digital converters, digital-to-analog converters, and other support circuits. Control and signal processing functions of the financial institute system 410 in which the processing device 413 resides may be allocated between these devices according to their respective capabilities. The processing device 413 also includes functionality to operate one or more software programs based on computer-executable program code portions thereof, which may be stored, along with the executable software code 415, in the electronic storage device 414 on the financial institute system 410.

The electronic storage device 414, as described herein, stores the executable software code 415 and the database 418. In some embodiments, the electronic storage device 414 may include volatile memory, such as RAM having a cache area for the temporary storage of information. The electronic storage device 414 may also include nonvolatile memory that may be embedded and/or removable. The non-volatile memory may additionally or alternatively include an Electrically Erasable Programmable Read-Only Memory (EEPROM), flash memory, and/or the like. The electronic storage device 414 can store any information and data that are used and administrated by the financial institute system 410 to implement the functions thereof.

It will be understood that the financial institute system 410 may be configured to implement any one or more portions of the various user interfaces and/or process flow described herein. It will also be understood that, in some embodiments, the electronic storage device 414 includes other applications. It will also be understood that, in some embodiments, the financial institute system 410 is configured to communicate with other entity and financial institute systems to obtain additional user data and benefits/offers.

The user system 420 can be a personal computer, electronic notebook or any computing device having networking capability and in communication with the financial institute system 410 through the network 450. In some embodiments, the user system 420 includes a communication device 411, at least one processor 423, and a memory 424 communicating with the processor 423. The memory 424 includes a user data/offer selection application 428 and a user interface 426, both of which, in some implementations, provided by the financial institute system 410. The user interface 426 can be launched by running the user data/offer selection application 428.

In some cases, the user interface 426, provided by the financial institute, can be installed on the user system 420, as part of a client-side application, which, as shown in FIG. 4, is the user data/offer selection application 428, also provided by the financial institute. The user interface 426 can be launched by running the client-side user data/offer selection application 428 that talks with the financial institute system 410. In some embodiments, the user interface is part of a server-side user data/offer selection application, built on the financial institute system, and can be presented to the user through a web browser by invoking the server-side application. A “client-side application” generally means that the application is stored and executed on a client's (or user's) computer; while a “server-side application” means that the application runs on a server's computer, which, in the present incident, is the financial institute system 410 that talks to the user system 420 through the network 450.

The entity system 430 can be any computerized apparatus controlled or operated by an entity in communication with other systems on the network 450. The entity system 430 includes a communication device 431, at least one processor 432, a memory 434, in communication with the processor 432, and a database 438 installed in the memory 434. The memory 434 has an offer application 437 built therein, which can talk to the user data/offer application 416 on the financial system 410 via the network 450 or indirectly talk to the user data/offer selection application 428 on the user system 420 through the financial system 410. The database 438 may contain information about benefits that the entity can offer in exchange for user data.

The external system 440 may include one or more third-party systems that are not financially associated with the financial institute system 410, for example, one or more other entity systems 442, which may wish to offer benefits to the user through the financial institute system 410 in return for the user data, and/or one or more other financial systems 444, which may have some information associated with the user or transactions involving the user.

The financial institute system 410, user system 420, entity system 430, and external system 440 are each operatively connected to the network 450 and communicate with one another there through. The network 450 can include various networking interfaces, such as a local area network (LAN), a wide area network (WAN), a global area network (GAN), such as Internet, or a hybrid thereof. The network 450 may be secure or unsecure and may also include wireless and/or wireline and/or optical interconnection technology.

FIG. 5A is one embodiment of a user interface 500, provided by a financial institute, for user selection of data components for each user data group. The user interface 500 allows the user to customize which data associated with the user is to be added to each user data group for a benefit exchange with an entity. The data group identifier 551 allows the user to navigate between each user data group. The transaction data selection section 552 allows a user to scroll through a plurality of purchases and other transaction-related information to determine which transaction data the user would like to associate with a user data group. The investment data selection section 553 allows a user to scroll through a plurality of investment-related information to determine which investment data the user would like to associate with a user data group. The account data selection section 554 allows a user to scroll through account-related information to determine which account data the user would like to associate with a user data group. The user provide data section 555 allows a user to scroll through user profile-related information to determine which user profile data the user would like at associate with a user data group. While transaction data, investment data, account data, and user profile data are shown in this display of the user interface 500, any other type of data may be used, including web browsing data, interests data, and miscellaneous data.

As illustrated in FIG. 5A, the display of the user interface 500 is configured to allow the user to select data related to specific transaction, investments, accounts, and the user profile, where the selected data is associated with user data group 1. At least Purchases 1-3, Investment 3, and User Profile Data 1 are currently selected by the user, and therefore are associated with user data group 1. In some embodiments, the user may then use the arrows in the data group identifier 551 to navigate to a different user data group. For example, the user may navigate to user data group 2. Upon navigating, the display of the user interface 500 may clear all of the selections that were made regarding user data group 1. Additionally, the display of the user interface 500 may remove data elements that were previously selected by the user to be associated with a different user data group. Alternatively, the display of the user interface 500 does not remove data elements that were previously selected by the user, so some data elements may be selected for multiple user data groups. The user may be allowed to name or re-name the user data groups so that the user may more easily remember which data is associated with which user data group. Once the data associated with the user data groups are selected, or not selected, at the discretion of the user, the display of the user interface 500 may progress to a form similar to that of FIG. 5B.

FIG. 5B is one embodiment of a user interface 500, provided by a financial institute, for user self-directed sharing of user data with entities in return for user benefits. The user interface 500 allows a user associated with the financial institute to select at least one data group to share with at least one entity, to view the benefits associated with the selected data groups (e.g., benefits associated with user data groups before selection by the user, or benefits provided by the entities , such as through a bid process or the like, after selection of the user data groups by the user), and decide what benefits the user would like in return for sharing the data (e.g., multiple offers may be presented by a single entity or by multiple entities for one or more of the user data groups). The user interface 500 comprises a user data section 502, a data details section 504, an available offers section 506, a benefits details section 508, and a select button 510. The user data section 502 has a first set of checkboxes (or other selection indicators), each corresponding to a user data group. The user can select one or more user data groups by clicking the checkboxes (or selecting the selection indicators) associated with the user data groups. A textbox may be associated with each user data group for displaying details of the selected aggregated user data group (e.g., the type of one or more of the data within one or more of the transaction, investment, user profile, account, or other like category of user data). In some embodiments, the data details section 504 may display the details about the user data group before and/or after they are selected by the user 460. In the example shown in FIG. 5B, the user has selected “Group 1” and “Group 4” to share, where each group includes user data (e.g., one or more types of data within one or more of the transaction, investment, user profile, account, or other like category of user data) that has been aggregated together by the user and/or the financial institute either automatically and/or by a specific selection.

In addition, as illustrated by the available offers section 506 the user 460 has also selected the offer (e.g., “Offer 2” from entity 2) in exchange for providing the user data associated with Group 1 and Group 4. In some embodiments, the available offers section 506 of the user interface 500 has a second set of checkboxes (or selection indicators), each corresponding to an offer from one or more entities for the selected user data groups. By selecting an offer, the user may also be selecting the entity with which the user data is shared. The benefits details section 508 shows details of the benefits associated with the selected offer, either before or after the benefits are selected by the user. As in this example, the user has selected “Offer 2” provided by “Entity 1”, the benefits details section 508 shows the details of the benefits of this offer, including an Entity 1 gift card worth $XXX.XX, a cash amount of $YYY.YY, and a Z% discount on a next purchase with the entity or an associated entity (e.g., a merchant). The benefits details section 508 may also prompts the user with a message regarding the user data groups and/or the benefits, such as for example “If you also select Group 5, you will receive the improved Offer 3.” In some embodiments, the prompt is initiated from the offer application 437 on the entity system 430 and presented to the user interface 500 through the user data/offer application 416 on the financial institute system 410. Finally, this example user interface 500 includes a selection indication (e.g., button) 510 which allows the system to receive an indication from the user that the user has finalized a selection of user data groups from the user data section 502 and one or more offers from the available offers section 506.

It should be understood that the user interface 500 illustrated in FIG. 5B is only one embodiment of the user interfaces 500 and the functions of the invention described herein. For example, in FIG. 5C, the user has selected different user data groups than in FIG. 5B (i.e., Groups 3, 4, and 5 instead of groups 1 and 4). These selections are illustrated in the user data section 502. As discussed above, the user has the option of deciding which user data groups the user desires to make available to an entity in exchange for one or more benefits. As a result of the user's changed user data group selection, the available offers section 506 is updated with offers from entities that are associated with the new user data groups (i.e., Offers 5-8). While the illustrated offers are different, there may be some overlap in some embodiments and the same offers may be available to exchange for separate combinations of user data groups. The user's selection of Offer 5B, associated with Entity 1, is shown in the available offers section 506 of FIG. 5C. The data details section 504 in FIG. 5C is populated with information for all three selected user data groups (i.e., Group 3, Group 4, and Group 5). Additionally, the benefits details section 508 displays information to the user regarding the benefits associated with Offer 5. Again, the benefits details 508 section also includes a notice to the user stating that if the user selects at least one more user data group to exchange, then the user may receive an improved offer.

In another embodiment, the user interface 500 allows the user to initially select an entity, or a group of entities, for which the user is interested in exchanging user data groups for benefits associated with such entities. In such an embodiment, the user will only be presented with offers that the user finds relevant. Additionally, the selected entity may provide a better offer based on the user's loyalty to the entity in selecting that entity.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise. In this regard, the term “processor” and “processing device” are terms that are intended to be used interchangeably herein and features and functionality assigned to a processor or processing device of one embodiment are intended to be applicable to or utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for user self-directed sharing of user data with entities in return for user benefits, the system comprising:
a computing platform comprising one or more processing devices and executable software code stored in one or more electronic storage devices, wherein the executable software code is configured to cause the one or more processing devices to:
receive user data associated with a user of a financial institution, wherein the user data comprises at least transaction data, investment data, account data and user profile data, and wherein the user data is received from financial institution systems or user computer systems;
aggregate the user data into at least two user data groups and store the at least two user data groups in the one or more storage devices;
receive, for each of the at least two user data groups, at least one benefit that at least one entity is willing to offer to the user in exchange for the at least one entity receiving the user data in the user data group, and wherein the at least one benefit is received from entity systems;
associate the at least one benefit with each of the at least two user data groups;
provide a user interface to the user, through the user computer systems;
prompt the user for selection of at least one of the at least two user data groups and the at least one benefit for each, wherein the prompt is provided through the user interface on the user system;
receive an indication that the user selected to share the at least one of the at least two user data groups in exchange for the at least one benefit, wherein the indication is received through the user system;
provide the user data associated with the at least one of the at least two user data groups to the entity associated with the at least one benefit selected, wherein the user data is provided by the financial institution system to the entity system; and
provide a notification to the user that the at least one benefit associated with the at least one of the at least two user data groups is associated with the user, wherein the notification is provided on the user interface through the user system.

2. The system of claim 1, wherein the executable software code of the system is further configured to cause the one or more processing devices to:
receive an indication that the user selected a non-sharing data group, wherein the non-sharing data group is one of the at least two user data groups that the user will not exchange with one of the at least one entities for one of the at least one benefits, wherein the indication is received through the user system; and
withhold the user data associated with the non-sharing data group from the at least one entity.

3. The system of claim 1, wherein the at least one benefit comprises at least one of cash, credits, discounts, loyalty points, added personal services, improved personal services, and better website experience.

4. The system of claim 1, wherein the value of the at least one benefit is increased based on an increase in the amount of user data provided in exchange for the benefit.

5. The system of claim 1, wherein the executable software code of the system is further configured to cause the one or more processing devices to:
provide a notification to the user that at least one additional benefit is available if the user will select at least one additional data group, based on the selected user data groups and at least one unselected user data group, wherein the at least one additional data group is the at least one unselected user data group;
prompt the user for selection of the at least one additional user data group and the at least one additional benefit for each, wherein the prompt is provided through the user interface on the user system;
receive an indication that the user selected to share the at least one additional user data group in exchange for the at least one additional benefit, wherein the indication is received through the user system;
provide the user data associated with the at least one additional user data group to the entity associated with the at least one additional benefit selected, wherein the user data is provided by the financial institution system or the entity system; and
provide a notification to the user of the at least one additional benefit associated with the at least one additional data groups is associated with the user, wherein the notification is provided on the user interface through the user system.

6. The system of claim 1, wherein the executable software code of the system is further configured to cause the one or more processing devices to:
prompt the user for selection of at least one of the at least one entity, wherein the prompt is provided through the user interface on the user system;
receive an indication that the user selected the at least one selected entity; and
prompt the user for selection of at least one of the at least two data groups and the at least one benefit for each, wherein the at least one benefit is associated with the at least one selected entity, and wherein the prompt is provided through the user interface on the user system.

7. A computer implemented method for user self-directed sharing of user data with entities in return for user benefits, the computer implemented method comprising:
receiving, via a processing device, user data associated with a user of a financial institution, wherein the user data comprises at least transaction data, investment data, account data, and user profile data, and wherein the user data is received from financial institution systems or user computer systems;
aggregating, via a processing device, the user data into at least two user data groups and store the at least two user data groups in the one or more storage devices;
receiving, via a processing device, for each of the at least two user data groups, at least one benefit that at least one entity is willing to offer to the user in exchange for the at least one entity receiving the user data in the user data group, and wherein the at least one benefit is received from entity systems;
associating, via a processing device, the at least one benefit with each of the at least two user data groups;
providing, via a processing device, a user interface to the user, through the user computer systems;
prompting, via a processing device, the user for selection of at least one of the at least two user data groups and the at least one benefit for each, wherein the prompt is provided through the user interface on the user system;
receiving, via a processing device, an indication that the user selected to share the at least one of the at least two user data groups in exchange for the at least one benefit, wherein the indication is received through the user system;
providing, via a processing device, the user data associated with the at least one of the at least two user data groups to the entity associated with the at least one benefit selected, wherein the user data is provided by the financial institution system to the entity system; and
providing, via a processing device, a notification to the user that the at least one benefit associated with the at least one of the at least two user data groups is associated with the user, wherein the notification is provided on the user interface through the user system.

8. The computer implemented method of claim 7, further comprising:
receiving, via a processing device, an indication that the user selected a non-sharing data group, wherein the non-sharing data group is one of the at least two user data groups that the user will not exchange with one of the at least one entities for one of the at least one benefits, wherein the indication is received through the user system; and
withholding, via a processing device, the user data associated with the non-sharing data group from the at least one entity.

9. The computer implemented method of claim 7, wherein the at least one benefit comprises at least one of cash, credits, discounts, loyalty points, added personal services, improved personal services, and better website experience.

10. The computer implemented method of claim 7, wherein the value of the at least one benefit is increased based on an increase in the amount of user data provided in exchange for the benefit.

11. The computer implemented method of claim 7, further comprising:
providing, via a processing device, a notification to the user that at least one additional benefit is available if the user will select at least one additional data group, based on the selected user data groups and at least one unselected user data group, wherein the at least one additional data group is the at least one unselected user data group;
prompting, via a processing device, the user for selection of the at least one additional user data group and the at least one additional benefit for each, wherein the prompt is provided through the user interface on the user system;
receiving, via a processing device, an indication that the user selected to share the at least one additional user data group in exchange for the at least one additional benefit, wherein the indication is received through the user system;
providing, via a processing device, the user data associated with the at least one additional user data group to the entity associated with the at least one additional benefit selected, wherein the user data is provided by the financial institution system or the entity system; and
providing, via a processing device, a notification to the user of the at least one additional benefit associated with the at least one additional data groups is associated with the user, wherein the notification is provided on the user interface through the user system.

12. The computer implemented method of claim 7, further comprising:
Prompting, via a processing device, the user for selection of at least one of the at least one entity, wherein the prompt is provided through the user interface on the user system;
Receiving, via a processing device, an indication that the user selected the at least one selected entity; and
Prompting, via a processing device, the user for selection of at least one of the at least two data groups and the at least one benefit for each, wherein the at least one benefit is associated with the at least one selected entity, and wherein the prompt is provided through the user interface on the user system.

13. A computer program product for user self-directed sharing of user data with entities in return for user benefits, the computer program product comprising a non-transitory computer readable medium comprising computer readable instructions, the instructions comprising instructions for:
receiving user data associated with a user of a financial institution, wherein the user data comprises at least transaction data, investment data, account data, and user profile data, and wherein the user data is received from financial institution systems or user computer systems;
aggregating the user data into at least two user data groups and store the at least two user data groups in the one or more storage devices;
receiving, for each of the at least two user data groups, at least one benefit that at least one entity is willing to offer to the user in exchange for the at least one entity receiving the user data in the user data group, and wherein the at least one benefit is received from entity systems;
associating the at least one benefit with each of the at least two user data groups;
providing a user interface to the user, through the user computer systems;
prompting the user for selection of at least one of the at least two user data groups and the at least one benefit for each, wherein the prompt is provided through the user interface on the user system;
receiving an indication that the user selected to share the at least one of the at least two user data groups in exchange for the at least one benefit, wherein the indication is received through the user system;
providing the user data associated with the at least one of the at least two user data groups to the entity associated with the at least one benefit selected, wherein the user data is provided by the financial institution system to the entity system; and
providing a notification to the user that the at least one benefit is associated with the at least one of the at least two user data groups is associated with the user, wherein the notification is provided on the user interface through the user system.

14. The computer program product of claim 13, further comprising:
receiving an indication that the user selected a non-sharing data group, wherein the non-sharing data group is one of the at least two user data groups that the user will not exchange with one of the at least one entities for one of the at least one benefits, wherein the indication is received through the user system; and
withholding the user data associated with the non-sharing data group from the at least one entity.

15. The computer program product of claim 13, wherein the at least one benefit comprises at least one of cash, credits, discounts, loyalty points, added personal services, improved personal services, and better website experience.

16. The computer program product of claim 13, wherein the value of the at least one benefit is increased based on an increase in the amount of user data provided in exchange for the benefit.

17. The computer program product of claim 13, further comprising:
providing a notification to the user that at least one additional benefit is available if the user will select at least one additional data group, based on the selected user data groups and at least one unselected user data group, wherein the at least one additional data group is the at least one unselected user data group;
prompting the user for selection of the at least one additional user data group and the at least one additional benefit for each, wherein the prompt is provided through the user interface on the user system;
receiving an indication that the user selected to share the at least one additional user data group in exchange for the at least one additional benefit, wherein the indication is received through the user system;
providing the user data associated with the at least one additional user data group to the entity associated with the at least one additional benefit selected, wherein the user data is provided by the financial institution system or the entity system; and
providing a notification to the user of the at least one additional benefit associated with the at least one additional data groups is associated with the user, wherein the notification is provided on the user interface through the user system.

18. The computer program product of claim 13, further comprising:
Prompting the user for selection of at least one of the at least one entity, wherein the prompt is provided through the user interface on the user system;
Receiving an indication that the user selected the at least one selected entity; and
Prompting the user for selection of at least one of the at least two data groups and the at least one benefit for each, wherein the at least one benefit is associated with the at least one selected entity, and wherein the prompt is provided through the user interface on the user system.
